(19) United States
(12) Patent Application Publication
(10) Pub. No.: US 2026/0239009 A1
(43) Pub. Date: Aug. 13, 2026

(54) Method for a Digital Vehicle Access System for Locating Or/and Granting an Access Authorization for a Mobile Terminal, Control Device for a Vehicle, and Vehicle Access System

(71) Applicant: Bayerische Motoren Werke Aktiengesellschaft, Muenchen (DE)

(72) Inventors: Tugce Erkilic CIVELEK, Muenchen (DE); Alaa MOURAD, Muenchen (DE)

(21) Appl. No.: 19/441,970

(22) Filed: Jan. 7, 2026

(30) Foreign Application Priority Data
Feb. 7, 2025 (DE) 10 2025 104 630.1

(51) Int. Cl. H04W 12/08; H04B 1/7163; H04W 64/00

(52) U.S. Cl. CPC H04W 12/08; H04B 1/7163; H04W 64/00

(57) ABSTRACT

A method for a digital vehicle access system for locating and granting an access authorization for a mobile terminal via a vehicle includes using a UWB protocol to locate the mobile terminal relative to the vehicle, using BLE channel sounding to locate the mobile terminal relative to the vehicle, and combining the localization data determined by the UWB protocol and the BLE channel sounding to determine the position of the mobile terminal relative to the vehicle. A control device for a vehicle and a vehicle access system are also provided.

### CROSS REFERENCE TO RELATED APPLICATION

This application claims priority under 35 U.S.C. §119 from German Patent Application No. DE 10 2025 104 630.1, filed February 7, 2025, the entire disclosure of which is herein expressly incorporated by reference.

### BACKGROUND AND SUMMARY

The increasing use of digital vehicle access systems means that the requirements for precision and reliability when locating mobile terminals are significantly increasing. Modern systems must not only ensure safe and user-friendly handling, but also be able to provide accurate localization information even under challenging conditions. Locating the respective mobile terminal – which may be, for example, a radio key, a smartphone, a smartwatch, a tablet or the like – is of great relevance insofar as, for example, the vehicle should only be able to be unlocked in a safe area in the immediate vicinity of the vehicle. For example, such an area can be a radius of 2 m around the vehicle. In so-called relay attacks, the communication between the vehicle and the mobile terminal is intercepted and forwarded by attackers. Precise localization helps to detect such attacks, since the vehicle can determine whether the signal is actually coming from the expected distance. In addition, comfort functions such as unlocking the vehicle only on the side on which the user of the mobile terminal is located can be implemented only by means of precise positioning of the mobile terminal.

One of the technologies commonly used in the prior art for positioning is Ultra Wideband (UWB). UWB is distinguished by its ability to perform precise distance measurements with high accuracy, even in complex environments. However, in real-world applications, the technology often faces challenges, such as signal interference, multi-path effects or limitations in the availability of resources, that can compromise localization reliability and consistency.

In addition, the integration of such technologies into existing systems is often associated with technical hurdles, in particular when different environments, usage profiles and security requirements need to be considered. These problems highlight the need for innovative approaches to overcoming existing limitations and increasing the performance of modern vehicle access systems.

It is an object of the invention to specify a method which avoids the aforementioned disadvantages and makes it possible to improve the reliable and precise localization of mobile terminals in vehicle access systems.

This object is achieved by the method according to the independent claims.

The method according to the invention for a digital vehicle access system for locating or/and granting an access authorization for a mobile terminal by means of a vehicle comprises the steps of using a UWB protocol to locate the mobile terminal relative to the vehicle, using Bluetooth Low Energy (BLE) channel sounding to locate the mobile terminal relative to the vehicle, and combining the localization data determined by means of the UWB protocol and the BLE channel sounding to determine the position of the mobile terminal relative to the vehicle by means of the vehicle.

The synergistic combination of UWB technology and BLE technology allows their respective advantages to be combined. Whereas on the one hand high positioning precision can be achieved by means of UWB technology, BLE-CS offers a greater range and can thus perform first positioning even at much larger distances. As soon as the user approaches the vehicle and undershoots a certain distance, the UWB method can be combined to improve the positioning accuracy.

In one particularly advantageous embodiment of the method, provision may be made for the vehicle to use the localization data combined by means of the UWB protocol and/or the BLE channel sounding to make a decision on the granting or refusal of access to vehicle functions for the mobile terminal. Part of this decision-making process is to authenticate the mobile terminal at the vehicle. This usually also requires the mobile terminal to be located in order to exclude relay attacks or the like. If the localization data obtained can be used to locate the mobile terminal at the correct distance, access to vehicle functions such as vehicle access can be granted.

In a specific configuration of the method, provision is made for the BLE channel sounding to use a phase-based distance measurement or/and a distance measurement using round-trip timing. In BLE channel sounding, for example, the vehicle as the initiator sends a signal with a certain frequency and amplitude to the mobile terminal as the reflector. The reflector measures the phase of the received signal and sends a response. From the comparison of the relative phase angle, the vehicle can infer the distance of the mobile terminal. In the case of distance measurement using round-trip timing, the round-trip time (RTT) is determined in a communication channel. This is the amount of time required by a signal to travel from an initiator to a reflector and back again. By evaluating the time of flight (ToF) – the time needed by a packet to be exchanged between the initiator and the reflector – the distance can be estimated. To achieve this, both devices record the time of arrival (ToA) and the time of departure (ToD). Analyzing the differences between the ToA and the ToD for the initiator and the reflector provides the data needed for a reliable distance calculation.

In one particularly preferred embodiment of the method, provision is made for the method to use a UWB protocol according to the 802.15.4ab standard or a later compatible protocol.

The 802.15.4ab standard or a compatible standard provides for Narrow Band Assisted (NBA) UWB communication. With NBA-UWB, tasks such as frequency and time synchronization are tackled via narrowband signals. The narrowband signal operates at a lower frequency than UWB and can operate at a higher transmit power, thus increasing the range. In addition, its transmission is inherently less susceptible to noise due to its narrow bandwidth. This improves the synchronization between UWB devices at greater distances.

In addition, the 802.15.4ab standard provides for a multi-millisecond (MMS) method. In the MMS method, the UWB distance measurement can be performed using packets. Each UWB packet can be divided into shorter fragments. The power of each transmission fragment is increased as far as possible under the regulations. The receiving UWB device receives appropriately aggregated information from these fragments, resulting in a combined transmission energy higher than that of the original UWB packet. This increased energy allows UWB devices to achieve greater ranges.

In this embodiment, only one of these two mentioned methods (NBA-UWB or MMS method) or a combination of the two methods can be used.

In a further development of the method, provision is made for a plurality of narrowband antennas to be used on the vehicle to combine data from a plurality of sensors for locating and/or analyzing the environment. In this way, the mobile terminal can be located particularly precisely relative to the vehicle.

In one embodiment of the method, provision is made for the method to pre-locate the mobile terminal at a greater distance from the vehicle by means of the BLE channel sounding. In this way, the special suitability of the BLE-CS method for early localization of the mobile terminal, which would not be possible with conventional 4z-UWB, can be achieved.

In one preferred embodiment of the method, provision is made for the pre-localization to be supplemented by the use of narrowband antennas using the UWB-802.15.4ab standard. This has the advantage that, in contrast to the 4z-UWB standard, a higher transmit power and thus a higher range can be achieved. In particular, a combination of the NBA-UWB standard with the BLE-CS method allows a significant improvement in range and accuracy when locating the mobile terminal at greater distances.

In one embodiment of the method, provision may be made for the angle of incidence to be measured by means of the UWB method according to the 802.15.4ab standard or/and for multi-millisecond-ranging sequences to be used. This combination with the BLE-CS method represents a particularly efficient embodiment.

The object is also achieved by a control device for a vehicle for carrying out one of the aforementioned methods and by a digital vehicle access system for locating or/and granting an access authorization for a mobile terminal by means of a vehicle having such a control device.

The invention will now be explained in more detail on the basis of an exemplary embodiment with reference to the figures, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic flowchart of a method for locating or/and granting an access authorization for a mobile terminal by means of a vehicle; and

FIG. 2 shows a schematic representation of a vehicle access system comprising a vehicle having a control device.

### DETAILED DESCRIPTION OF THE DRAWINGS

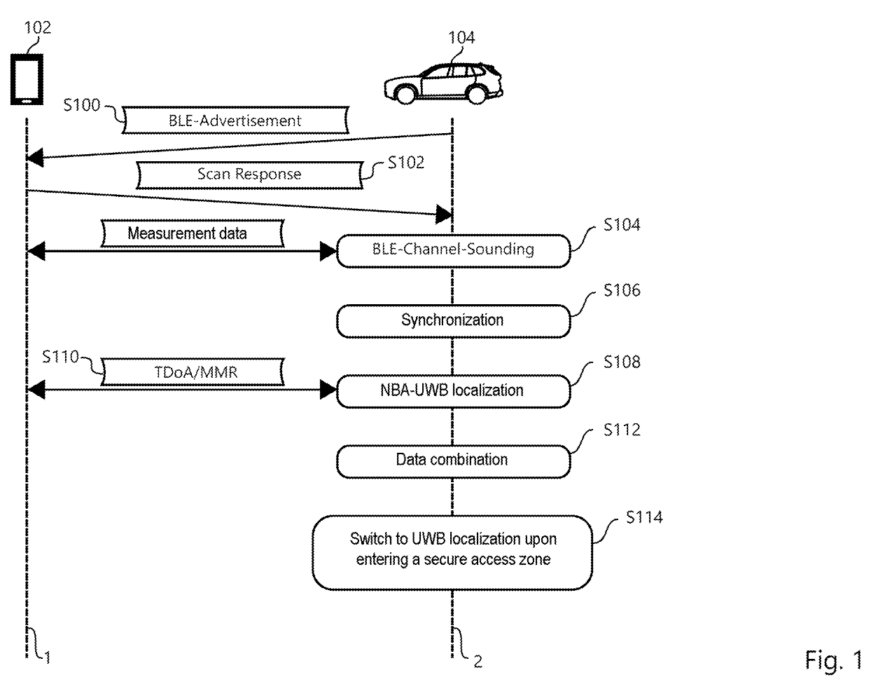

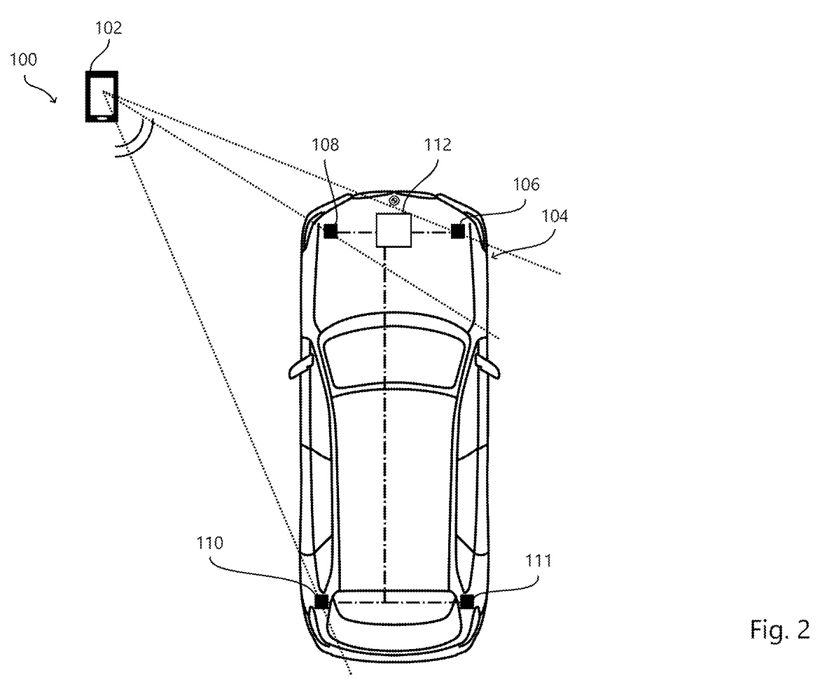

An embodiment of a method for a digital vehicle access system for locating and/or granting an access authorization for a mobile terminal device by means of a vehicle is now described with reference to FIGS. 1 and 2. The system 100 comprises – as shown in FIG. 2 – a mobile terminal 102 and a vehicle 104. The mobile terminal 102 may be, for example, a radio key or a smartphone, a smartwatch, a tablet, etc., which is configured to trigger vehicle functions on the vehicle 104 via a digital communication channel by means of a digital key. A mobile terminal 102 is shown by way of example. It goes without saying that two or more mobile terminals can also be present in the vehicle access system 100. The vehicle functions to be triggered may be, for example, the locking or unlocking of vehicle flaps such as doors, etc., in order to gain access to the interior of the vehicle or/and to change the vehicle to readiness for driving.

For granting an access authorization for the mobile terminal 102 to the vehicle 104, it is usually a prerequisite that the mobile terminal 102 has been sufficiently well located by the vehicle 104. For this purpose, transceiver units 106, 108, 110, 111 which are connected to a control device 112 are provided in the vehicle 104. In the initial example shown in FIG. 2, the transceiver units 106-111 are designed for both BLE and UWB signals and are configured to both send and receive signals in the respective frequency band. This is only an exemplary embodiment. It goes without saying that BLE and UWB signals can also be received and processed by separate units. Provision may also be made for the sending and receiving operations to be carried out in separate units. Furthermore, provision may be made for separate transmitting and/or receiving units to also be provided for the UWB signals. As already mentioned in the introduction, the frequency band for the conventional UWB and that for the NBA-UWB differ, and so different receiving and radiating antennas may possibly be provided for this purpose.

The mobile terminal 102 is equally capable of sending and receiving in the required frequency bands.

The already mentioned control device 112 of the vehicle 104 is configured to further process the signals captured by the transceivers 106-111 or to carry out corresponding communication with the terminal 102 via the respective channel via the transceivers 106-111 and to trigger corresponding actions in the vehicle 104. In particular, the control device 112 is designed to perform the method described below.

FIG. 1 shows the time lines of the involved entities mobile terminal 102 and vehicle 104 in vertical dashed lines 1, 2 as running from top to bottom. The method first begins with a step S100 in which the vehicle 104 sends out a BLE advertisement.

In the method shown in FIG. 1, interaction between BLE communications and NBA-UWB signals is shown by way of example. The method shown should be understood merely by way of example in the form shown. Both the type and the sequence of the BLE and NBA-UWB signals are only exemplary and may also be different depending on the implementation of the technologies.

The BLE advertisement carried out in step S100 is carried out at regular intervals of time by the vehicle 104. If such a BLE advertisement is received by the mobile terminal 102, it responds with a scan response packet containing information about the mobile terminal 102 (S102).

As soon as the vehicle 104 has received the scan response packet from the mobile terminal 102, it begins the so-called BLE channel sounding method (S104). In this case, signals are sent from the vehicle 104 to the mobile terminal 102, and so the vehicle 104 acts as an initiator. The mobile terminal 102 sends response signals and thus acts as a reflector. In this way, the vehicle 104 gains information in order to carry out a first rough position determination of the mobile terminal 102. The signals transmitted from the mobile terminal 102 may contain, for example, phase or timing information. For example, signal strengths (RSSI) or timing data such as round-trip time (RTT) can be transmitted.

In the following step (S106), the vehicle 104 can use the BLE-CS data for time and frequency synchronization with the mobile terminal 102. For example, a frequency reference or a time stamp from the BLE-CS measurements can be transmitted. In this way, the communication taking place in the following steps can already take place on a synchronized basis.

In the next step (S108), accurate NBA-UWB localization can be initiated. Various technologies such as the TDoA method (time difference on arrival) or multi-millisecond ranging can be performed (S110). Alternatively, parts of the NBA-UWB localization, such as the determination of the arrival angle in combination with the BLE channel sounding, can be started. In this way, the BLE technology can be synergistically supplemented or supported by the NBA-UWB localization, or vice versa, the NBA-UWB localization can resort to information from the BLE channel sounding method and can thus improve localization.

This is shown by way of example in the diagram in FIG. 1 with the term data combination (S112).

It should have become clear from the above that the exact timing of the method shown in FIG. 1 is not fixed, but should only be shown here by way of example. For example, it may also happen that NBA-UWB localization initially first takes place and in a further step the BLE channel sounding is additionally included.

As soon as the mobile terminal 102 is in a secure access zone, it is possible to resort to the conventional UWB positioning method (S114) which enables even more precise positioning of the mobile terminal. Here, too, it is possible to additionally or alternatively resort to one of the two or simultaneously to both mentioned methods (BLE/NBA-UWB). In this state, it may also ultimately be decided whether to grant or refuse access to the vehicle 104 or to functions of the vehicle 104.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for a digital vehicle access system for locating and granting an access authorization for a mobile terminal via a vehicle, the method comprising:
using an Ultrawide Band (UWB) protocol to locate the mobile terminal relative to the vehicle;
using Bluetooth Low Energy (BLE) channel sounding to locate the mobile terminal relative to the vehicle; and
combining localization data determined by the UWB protocol and the BLE channel sounding to determine the position of the mobile terminal relative to the vehicle.

2. The method according to claim 1, wherein the vehicle uses the localization data combined by the UWB protocol or the BLE channel sounding to make a decision on granting or refusal of access to vehicle functions for the mobile terminal.

3. The method according to claim 1, wherein the BLE channel sounding uses a phase-based distance measurement or a distance measurement using round-trip timing.

4. The method according to claim 2, wherein the BLE channel sounding uses a phase-based distance measurement or a distance measurement using round-trip timing.

5. The method according to claim 1, wherein the method uses the UWB protocol according to the 802.15.4ab standard or a later compatible protocol.

6. The method according to claim 2, wherein the method uses the UWB protocol according to the 802.15.4ab standard or a later compatible protocol.

7. The method according to claim 5, wherein the method uses Narrow Band Assisted UWB (NBA-UWB).

8. The method according to claim 5, wherein the method uses multi-millisecond-ranging sequences.

9. The method according to claim 7, wherein the method uses multi-millisecond-ranging sequences.

10. The method according to claim 7, wherein the method pre-locates the mobile terminal at a greater distance from the vehicle via the BLE channel sounding.

11. The method according to claim 8, wherein the method pre-locates the mobile terminal at a greater distance from the vehicle via the BLE channel sounding.

12. The method according to claim 10, wherein the pre-localization is supplemented by the use of narrowband antennas using the UWB-802.15.4ab standard.

13. The method according to claim 12, wherein an angle of incidence is measured via the UWB method according to the 802.15.4ab standard or multi-millisecond-ranging sequences are used.

14. A control device for a vehicle for carrying out a method according to claim 1.

15. A digital vehicle access system for locating and granting an access authorization for a mobile terminal via a vehicle having a control device according to claim 14.
